(19) United States
(12) Patent Application Publication
(10) Pub. No.: US 2016/0076666 A1
(43) Pub. Date: Mar. 17, 2016

(54) FUEL TANK VALVE

(71) Applicant: GM GLOBAL TECHNOLOGY OPERATIONS LLC, Detroit, MI (US)

(72) Inventors: Jeffery J. Milton, Lake Orion, MI (US); William L. Villaire, Clarkston, MI (US)

(21) Appl. No.: 14/487,512

(22) Filed: Sep. 16, 2014

(51) Int. Cl. F16K 31/20; F17C 13/02

(52) U.S. Cl. CPC F16K 31/20; F17C 13/021

(57) ABSTRACT

A fuel tank has a valve assembly that reduces noise emanating therefrom. The fuel tank comprises a first fuel reservoir, a second fuel reservoir, a fuel pick-up assembly disposed within the first fuel reservoir, a fuel inlet in the fuel pick-up assembly, a fuel pump assembly disposed in the second fuel reservoir and fluidly connected to the fuel pick-up assembly and a low shut-off valve associated with the fuel inlet of the fuel pick-up assembly and configured to close when fuel in the first reservoir drops below the level of the low shut-off valve, eliminating noise generated by a lack of fuel entering the fuel pick-up assembly.

### FIELD OF THE INVENTION

The subject invention is related to the fuel tank of a vehicle and, more particularly, to a fuel tank having a valve assembly that reduces noise emanating therefrom.

### BACKGROUND

Fuel tanks are utilized to store fuel in vehicles typically for consumption by an internal combustion engine. In some vehicles, due to packaging limitations or the desire to increase the capacity of fuel for the purpose of extending vehicle range, fuel tanks may be configured with multiple fuel reservoirs. Such fuel tanks may be referred to as saddle tanks.

In a multiple reservoir, or saddle tank fuel system, a fuel pump may be positioned in each reservoir, or a fuel pump maybe located in one reservoir with a fluidly connected “pickup” extending into the second reservoir. In either case, the fuel system may draw fuel from one fuel reservoir until that reservoir's capacity is diminished and then draw fuel from the second reservoir until tank refill is required. Occasionally, upon emptying of the first fuel reservoir, a noise may be emitted from the fuel pump intake or pickup in the first fuel reservoir. Such a sound may be described as a gurgling sound which, while not indicative of a fuel system functional issue, is undesirable from a passenger noise perspective.

### SUMMARY OF THE INVENTION

In one exemplary embodiment of the invention a fuel tank having a valve assembly that reduces noise emanating therefrom, comprises a first fuel reservoir, a second fuel reservoir, a fuel pick-up assembly disposed within the first fuel reservoir, a fuel inlet in the fuel pick-up assembly, a fuel pump assembly disposed in the second fuel reservoir and fluidly connected to the fuel pick-up assembly and a low shut-off valve associated with the fuel inlet of the fuel pick-up assembly and configured to close when fuel in the first reservoir drops below the level of the low shut-off valve, eliminating noise generated by a lack of fuel entering the fuel pick-up assembly.

In another exemplary embodiment of the invention a vehicle fuel system having a valve assembly that reduces noise emanating therefrom comprises a first fuel reservoir, a second fuel reservoir, a fuel pick-up assembly disposed within the first fuel reservoir, a fuel inlet in the fuel pick-up assembly, a fuel pump assembly disposed in the second fuel reservoir and fluidly connected to the fuel pick-up assembly and a low shut-off valve associated with the fuel inlet of the fuel pick-up assembly. The low fuel shut-off valve comprises a valve housing having an inlet opening and an outlet, the outlet fluidly connected with the fuel inlet of the fuel pick-up assembly, a valve chamber defined within the valve housing between the inlet opening and the outlet and a moveable valve assembly disposed in the valve chamber and configured to seat against a valve seat that is defined inside of, and about, the inlet opening of the valve housing, wherein the low shut-off valve is configured to close when fuel in the first reservoir drops below the level of the inlet opening, eliminating noise generated by a lack of fuel entering the fuel pick-up assembly.

The above features and advantages, and other features and advantages of the invention, are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a plan view, partially in section, of a multiple reservoir fuel tank embodying features of the invention;

FIG. 2 is an enlarged view of a portion of FIG. 1;

FIG. 3A is a schematic view of a fuel tank valve taken at circle 3, in an open position, embodying features of the invention; and

FIG. 3B is a schematic view of a fuel tank valve taken at circle 3, in a closed position, embodying features of the invention.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features. As used herein, the term vehicle is not limited to just an automobile, truck, van or sport utility vehicle, but includes any self-propelled or towed conveyance suitable for transporting a burden.

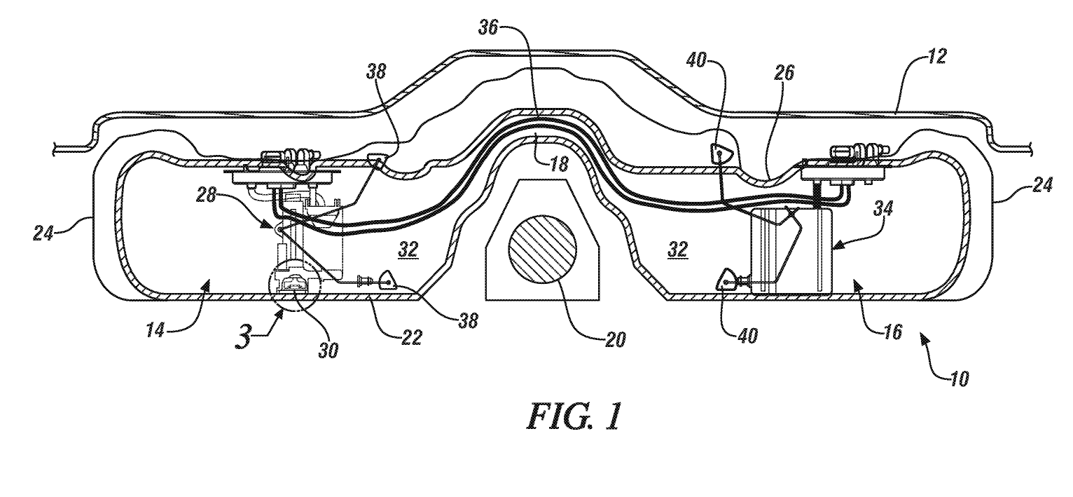

Referring to FIG. 1, in an exemplary embodiment, a fuel tank system 10 for a vehicle 12 is illustrated. The fuel tank system 10 is of the type having multiple fuel reservoirs; in the illustrative example shown, first fuel reservoir 14 and second fuel reservoir 16. The fuel tank system 10 comprises a single tank having a continuous bridge portion 18 extending between first and second fuel reservoirs 14, 16, and may be referred to as a saddle tank. Other fuel tank systems that may also embody the invention may include separate first and second fuel reservoirs 14, 16 absent the continuous bridge portion 18. Fuel tank systems 10 of the type illustrated in FIG. 1 are useful in order to provide adequate fuel storage on board vehicle 12 when, for instance, a powertrain component such as propeller shaft 20 extends longitudinally through the space normally occupied by a single reservoir fuel tank.

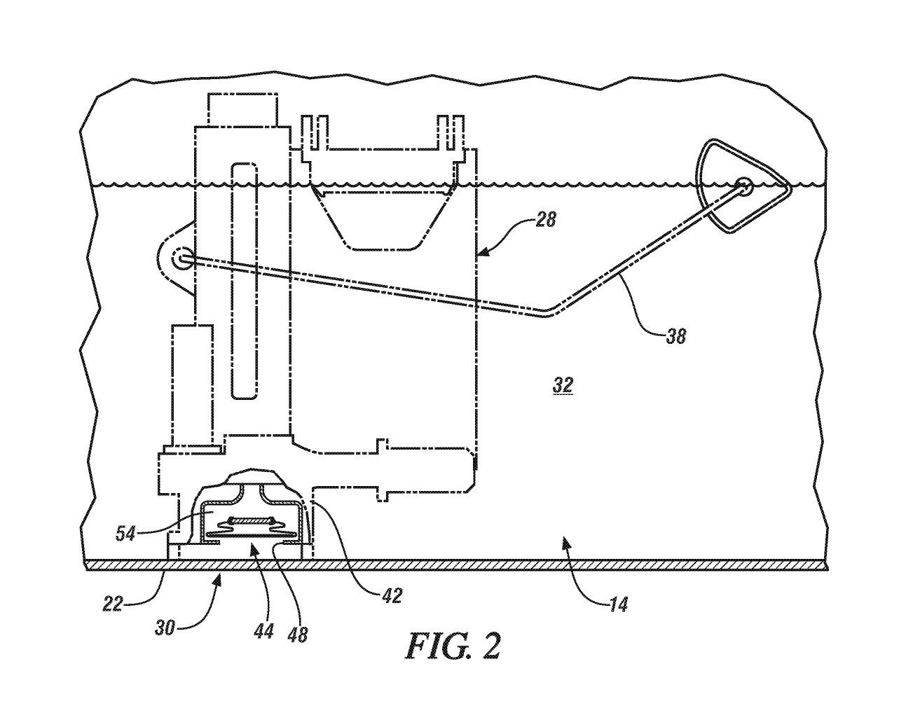

The fuel tank system 10 may be constructed of sheet metal or a composite material defining a bottom 22, sides 24 and an upper surface or top portion 26. Disposed in the first fuel reservoir 14 is a fuel pick-up assembly 28 (illustrated in greater detail in FIG. 2). The fuel pick-up assembly is, in an embodiment, disposed within the first fuel reservoir 14 such that an integral fuel inlet 30 is positioned near or adjacent to the bottom 22 of the reservoir in a location that promotes full usage of the fuel supply 32 therein. The fuel pick-up assembly 28, which may or may not include a pump mechanism, is fluidly connected to a fuel pump assembly 34 that is disposed in the second fuel reservoir 16. The fluidic connection is established through fuel transfer conduits 36 that extend between the fuel pick-up assembly 28 and the fuel pump assembly 34. A first fuel level sender 38 may be configured as part of the fuel pick-up assembly 28 while a second fuel level sender 40 is configured as a part of the fuel pump assembly 34. If equipped, each fuel level sender 38, 40 may be signally connected to a fuel system monitor or module, not shown, that monitors the fuel level in each of the first and second fuel reservoirs 14, 16, respectively and informs the vehicle operator of the overall fuel level status via one or more instrument panel mounted gages, or the like.

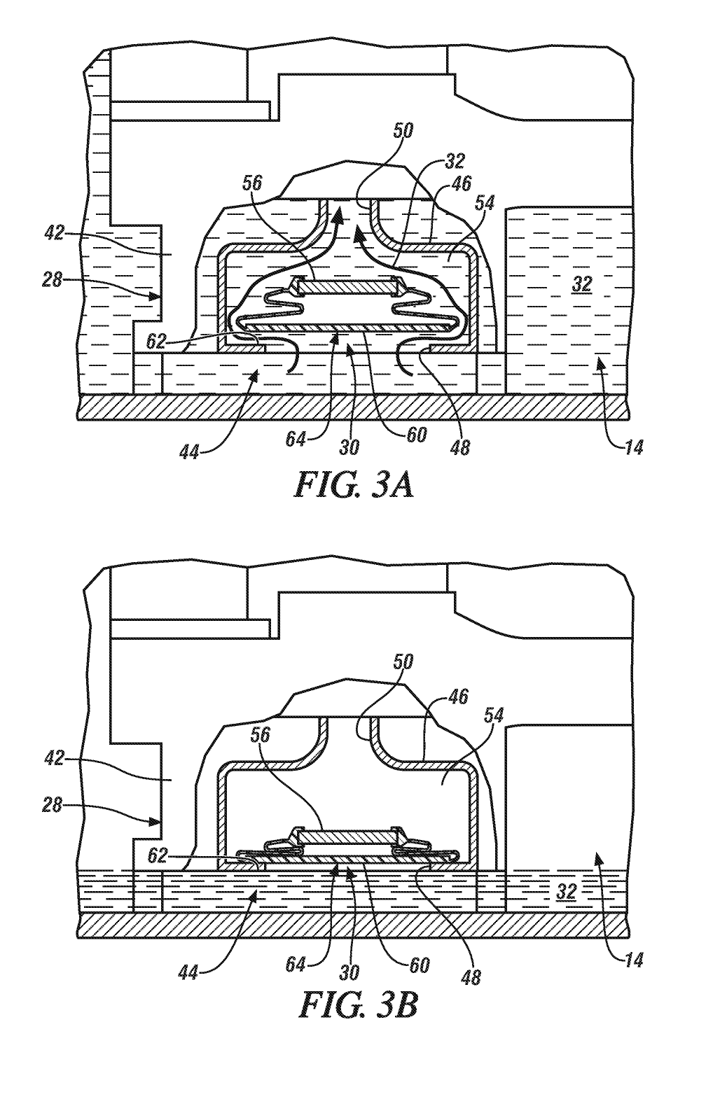

Referring now to FIGS. 3A and 3B, with continuing reference to FIGS. 1 and 2, a low fuel shut-off valve 44 is configured for placement in the fuel inlet 30 of the fuel pick-up assembly 28. The low fuel shut-off valve may include a valve housing 46 having an inlet opening 48, and an outlet 50 that is fluidly connected with a fuel transfer conduit 36. The valve housing 46 may be configured to be installed within the housing 42 of the fuel pick-up assembly 28 or may be situated alone in the fuel reservoir 14 in fluid communication with the fuel transfer conduit 36 through other means such as a fuel straw or other type of fuel pick-up extending therebetween. Defined within the valve housing 46 of the low fuel shut-off valve 44, between the inlet opening 48 and the outlet 50 is a valve chamber 54. Disposed within the valve chamber is a weighted valve member 56 and a seal member 60. The seal member 60 is positioned between the weighted valve member and the inlet opening 48. The seal member 60 is configured to seat, as described herein, against a valve seat 62 that is defined inside of, and about, the inlet opening 48 of the valve housing 46. The weighted valve member 56 and the seal member 60 may be attached to one another to comprise a moveable valve assembly 64 that travels (up and down as viewed in FIGS. 3A and 3B) between an opened position in which the valve assembly is lifted off of the valve seat 62, FIG. 3A, to a closed position in which the valve assembly is seated against the valve seat FIG. 3B. When the moveable valve assembly 64 is in the opened position, fuel 32 may flow through the valve housing 46 from the inlet opening 48, through the valve chamber 54 to the outlet 50.

During operation of the vehicle 12, the fuel pump assembly 34 draws fuel from the first fuel reservoir 14 via the fuel pick-up assembly 28, for instance, via the fuel transfer conduit 36. The weighted valve member 56 is constructed of a material such as plastic or other suitable material that will float as long as fuel 32 is present in the reservoir 14 above the level of the inlet opening 48 in the valve housing 46 of the low fuel shut-off valve (FIG. 3A). When fuel in first fuel reservoir 14 drops below the level of the inlet opening 48, the weighted valve member 56 will cause the seal member 60 of the moveable valve assembly to seat against the valve seat 62 as it loses buoyancy due to the drop in fuel level. By closing the valve seat 62 and, thus, the inlet opening 48 of the low fuel shut-off valve 44, noise that may otherwise be generated due to a lack of fuel entering the fuel pick-up assembly 28 is eliminated.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation of material to the teachings of the invention without departing from the essential scope thereof. Therefore, it is intended that the invention not be limited to the particular embodiments disclosed, but that the invention will include all embodiments falling within the scope of the application.

What is claimed is:

1. A fuel tank system having a valve assembly that reduces noise emanating therefrom, comprising:
a first fuel reservoir;
a second fuel reservoir;
a fuel pick-up assembly disposed within the first fuel reservoir;
a fuel inlet in the fuel pick-up assembly;
a fuel pump assembly disposed in the second fuel reservoir and fluidly connected to the fuel pick-up assembly;
a low fuel shut-off valve associated with the fuel inlet of the fuel pick-up assembly and configured to close when fuel in the first fuel reservoir drops below the level of the low fuel shut-off valve, eliminating noise generated by a lack of fuel entering the fuel pick-up assembly.

2. The fuel tank system of claim 1, wherein the fuel tank system comprises a single tank connected by a continuous bridge portion.

3. The fuel tank system of claim 1, wherein the fuel pick-up assembly fuel inlet is configured to receive the low fuel shut-off valve therein.

4. The fuel tank system of claim 1, the low fuel shut-off valve further comprising:
a valve housing having an inlet opening and an outlet, the outlet fluidly connected with the fuel inlet of the fuel pick-up assembly;
a valve chamber defined within the valve housing, between the inlet opening and the outlet;
a moveable valve assembly disposed in the valve chamber, configured to seat against a valve seat that is defined inside of, and about, the inlet opening of the valve housing.

5. The fuel tank system of claim 4, the moveable valve assembly further comprising a weighted valve member and a seal member, the seal member positioned between the weighted valve member and the valve seat.

6. The fuel tank system of claim 5, wherein the weighted valve member is constructed of a material that will float when fuel is present in the first reservoir above the level of the inlet opening in the valve housing of the low fuel shut-off valve and, when fuel in the first fuel reservoir drops below the level of the inlet opening, the weighted valve member moves the seal member of the moveable valve assembly to seat against the valve seat as it loses buoyancy due to the drop in fuel level.

7. The fuel tank system of claim 1, wherein the fuel pick-up assembly is disposed in the fuel reservoir in fluid communication with the fuel transfer conduit through a fuel straw.

8. A vehicle fuel system having a valve assembly that reduces noise emanating therefrom, comprising:
a first fuel reservoir;
a second fuel reservoir;
a fuel pick-up assembly disposed within the first fuel reservoir;
a fuel inlet in the fuel pick-up assembly;
a fuel pump assembly disposed in the second fuel reservoir and fluidly connected to the fuel pick-up assembly;
a low fuel shut-off valve associated with the fuel inlet of the fuel pick-up assembly comprising:
a valve housing having an inlet opening and an outlet, the outlet fluidly connected with the fuel inlet of the fuel pick-up assembly;
a valve chamber defined within the valve housing between the inlet opening and the outlet;
a moveable valve assembly, disposed in the valve chamber, configured to seat against a valve seat that is defined inside of, and about, the inlet opening of the valve housing, wherein the low fuel shut-off valve is configured to close when fuel in the first reservoir drops below the level of the inlet opening, eliminating noise generated by a lack of fuel entering the fuel pick-up assembly.

9. The vehicle fuel system of claim 8, wherein the first fuel reservoir and the second fuel reservoir are connected by a continuous bridge portion to define a single fuel tank.

10. The vehicle fuel system of claim 8, wherein the fuel pick-up assembly fuel inlet is configured to receive the low fuel shut-off valve therein.
